(19) United States
(12) Patent Application Publication
(10) Pub. No.: US 2016/0132593 A1
(43) Pub. Date: May 12, 2016

(54) METHOD AND SYSTEM FOR AUDIO SIGNAL RECOGNITION AND CLOUD SEARCH ARCHITECURE UTILIZING SAME

(71) Applicants: Marcia Elizabeth Christian Favale, Watermill, NY (US); Robert Thomas Stanicic, Houston, TX (US)

(72) Inventors: Marcia Elizabeth Christian Favale, Watermill, NY (US); Robert Thomas Stanicic, Houston, TX (US)

(21) Appl. No.: 14/937,801

(22) Filed: Nov. 10, 2015

Related U.S. Application Data
(60) Provisional application No. 62/077,770, filed on Nov. 10, 2014.

(51) Int. Cl. G06F 17/30; G06F 3/16

(52) U.S. Cl. CPC G06F 17/30743; G06F 17/30769; G06F 3/165

(57) ABSTRACT

A system and method of identifying and locating an item and/or information about an item set forth in a file from locations external to the file are disclosed. In at least one embodiment, the system and method can implement a pattern recognition algorithm to provide information regarding the item. In at least one embodiment, the pattern recognition algorithm can comprise one or more voice recognition algorithms.

### CROSS REFERENCE TO RELATED APPLICATIONS

This application claims priority to U.S. Provisional Application No. 62/077,770, filed Nov. 10, 2014, the contents of which are entirely incorporated by reference herein.

### FIELD OF TECHNOLOGY

The subject matter herein generally relates to audio signal recognition and cloud search architectures, specifically, recognizing an audio signal and searching a cloud search architecture for similarity data.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

In at least one embodiment of the present technology, a system and method of identifying and locating an item and/or information about an item set forth in an electronic file from locations external to the electronic file are disclosed. In at least one embodiment, the system and method can implement a pattern recognition algorithm to provide information regarding the item. In at least one embodiment, the pattern recognition algorithm can comprise one or more voice recognition algorithms

In some embodiments, a method, system and non-transitory method for audio signal recognition and searching a cloud architecture is disclosed. The method can include receiving, at a server, an audio signal and identifying information. The method can also include calculating an audio print of the audio signal and retrieving, from a database, a catalog based on a match of the audio print. Finally, the method can include organizing the catalog based on the identifying information and transmitting, form the server, the catalog.

In some embodiments, the method can include that the audio signal is portion of a larger audio signal. In some embodiments, the method can include that the audio signal can be associated with a video signal.

In some embodiments, the method can include that the identifying information is a current location. In some embodiments, the method can include that the identifying information is a preference.

In some embodiments, the method can include that the catalog includes one or more products or services. In some embodiments, the method can also include the catalog is organized based on a current playback time of the audio signal.

### BRIEF DESCRIPTION OF THE DRAWINGS

Implementations of the present technology will now be described, by way of example only, with reference to the attached figures, wherein:

FIG. 1 is a flow chart of a method for organizing and displaying products and services according to an embodiment of the present disclosure;

FIG. 2 is a flow chart of a method for search and audio recognition according to an embodiment of the present disclosure;

FIG. 3 is a block diagram of an example data architecture according to an embodiment of the present disclosure;

FIG. 4 is a block diagram of an example system architecture according to an embodiment of the present disclosure; and

FIG. 5 is a block diagram of an example system architecture according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The description is not to be considered as limiting the scope of the embodiments described herein.

The system can enable a computing device to interact with an external electronic device, such as a cable box, gaming system, server, smart television, to search for artistic works and display one or more related products shown in the artistic work. The system correlates an artistic work with a catalog of products, services, and destinations featured in the artistic work through the use of audioprints. The system captures in its database the history of audioprints watched or requested by the viewer, and associates audioprints with user preferences, geographic location, product impression and clickthrough history to suggest products, services and destinations targeting the user based on preference, location, and consumer behavior. The system correlates audioprints with audioprints from related artistic works. The system also captures information on user-voting counts for artistic works and products and services to be created in the catalog. This data is associated with audioprints and can be used to predict demand for artistic works and product purchases. The system can organize the catalog of products in response to the captured information of user-voting, preferences, geo-location, or any other identifying information.

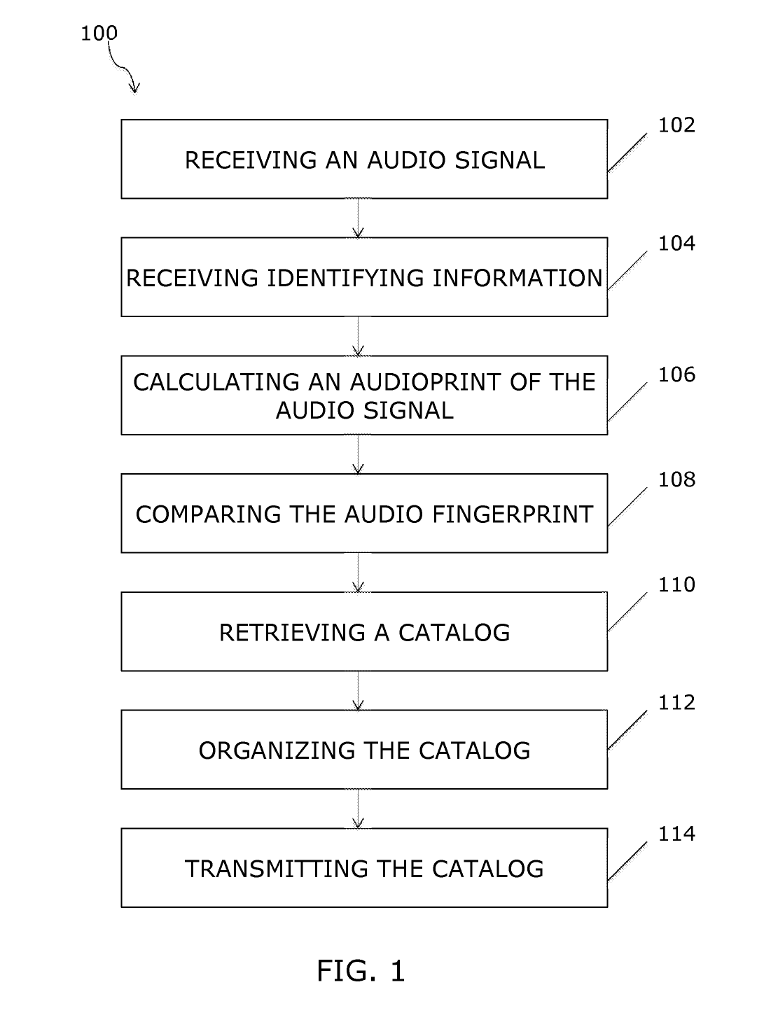

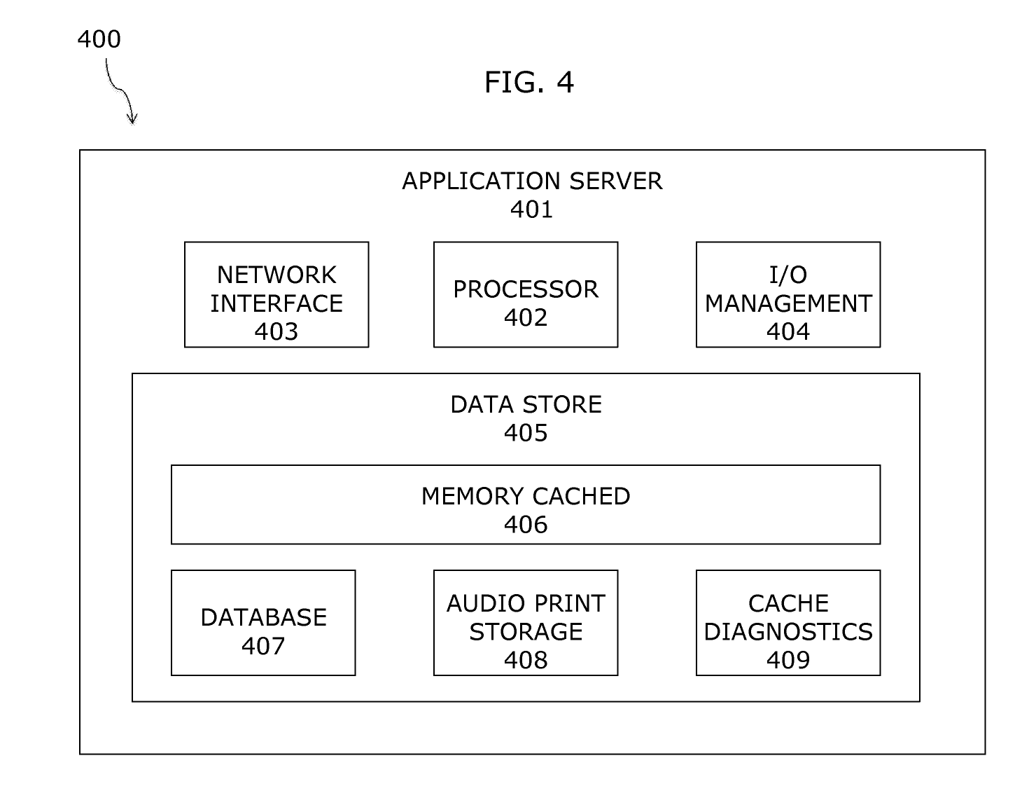

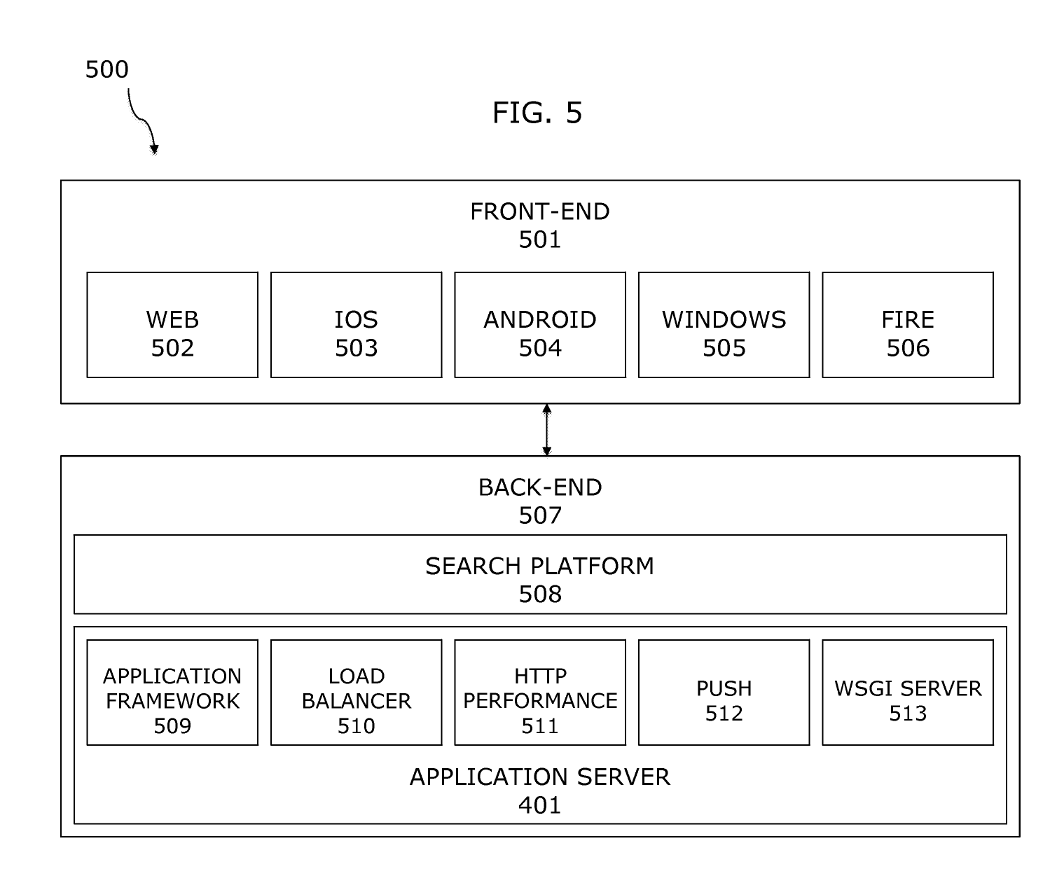

Referring to FIG. 1, a flowchart is presented in accordance with an example embodiment. The example method 100 is provided by way of example, as there are a variety of ways to carry out the method. Each block shown in FIG. 1 represents one or more processes, methods or subroutines, carried out in the example method 100. Furthermore, the illustrated order of blocks is illustrative only and the order of the blocks can change according to the present disclosure. Additional blocks may be added or fewer blocks may be utilized, without departing from this disclosure. The blocks illustrated in FIG. 1 can be implemented in a system illustrated in FIGS. 4-5. The flow charts illustrated in FIG. 1, will be described in relation to and make reference to at least application server 401, back-end 507, front-end 501, and search platform 508 as illustrated in FIGS. 4-5. The example method 100 can begin at block 102.

At block 102, an application server 401 can receive a search request. For example, a user can input a search request (e.g., a portion of an audio signal of a presently playing artistic work, one or more alphanumeric characters, portion of a video signal, etc.) and the search request can be transmitted over a communications network (e.g., the Internet, etc.) to the application server 401. In the illustrated method, the search request is an audio signal. In some embodiments, the search request input can be from a software application, web site or search engine (e.g., search platform 508). The search request can include artistic works (e.g., song, artist, movie, television show, performance, etc.), products (e.g., clothes, shoes, vacations, sports, tickets, etc.) and services (e.g., travel, airline, hotels, restaurants, etc.) of interest or for purchase. The search request can be text search, voice search, image search, visual recognition software, or audio recognition software that matches a unique audio prints associated with each product or service placed in the artistic work. When the search request is received at the application server 401, method 100 can proceed to block 104.

At block 104, the application server 401 can receive identifying information associated with the search request. The identifying information can include personal information of the user. For example, the personal information can include preferences (e.g., artistic works, products, and services), previous purchases, and previous searches. In at least one embodiment, the user can elect whether to provide the personal information. In some embodiments, the personal information can be stored and retrieved from a user profile. The identifying information can also include real-time geo-location data associated with the search request. For example, the real-time geo-location data can be transmitted from a front-end electronic device 501 (e.g., smartphone, laptop, tablets, etc.) of the user to the application server 401. In some embodiments, the front-end electronic device 501 can provide the real-time geo-location data automatically. In some embodiments, the user can elect whether to provide the real-time geo-location data. In other embodiments, the real-time geo-location data is not provided and the application server 401 can set the real-time geo-location data to a predetermined default value. When the application server 401 has received the real-time geo-location data the method 100 can proceed to block 106.

At block 106, the application server 401 calculates an audio print of the search request. The search request can be an audio signal having a specific audio print. An audio print can be a condensed digital summary, deterministically generated from an audio signal, that can be used to identify an audio sample or quickly locate similar items in an audio database. When the application server 401 has calculated the audio print, method 100 can proceed to block 108.

At block 108, the application server 401 can compare the audio print of the search request to a database of tagged audio prints. The database of a tagged audio prints can be local to the application server 401 or located externally to the application server 401 and accessible over a communication network. The database of tagged audio prints can include artistic works of any media type, such as audio, or video associated with a specific catalog. The catalog can reference products, services, locations, or other artistic works associated with the tagged audio print. When the application server has compared the audio print, the method 100 can proceed to block 110.

At block 110, the application server 401 can retrieve a catalog based on the search request or audio print. For example, the application server 401 can retrieve a catalog from database 404 based on the received search request. In one embodiment, the search request can be an artistic work and the catalog can include products and services related to the artistic work (e.g., products and services displayed within the artistic work). In other embodiments, the catalog can be retrieved from a merchant database. In yet other embodiments, the merchant can provide a catalog stored on database 404. For example, a merchant can provide product endorsement contracts, products placed in the artistic work, and/or all products and services offered by the merchant. Artists and producers can provide artistic works, information regarding cast, location of production, product placement, and product endorsement contracts. The data provided by the merchants, artists, and producers can all be included in the catalog. When the application server 401 has retrieved the catalog, method 100 can proceed to block 112.

At block 112, the catalog can be organized. In some embodiments, the catalog can be organized by the identifying information provided at block 104. For example, the catalog can be organized to display products and services that are closely located to the user and that the user is most interested in viewing. In some embodiments, the catalog can be organized by matching the geo-location data, the search request, and the personal information. In other embodiments, the catalog can be organized by matching the artistic works, geo-location data and endorsement contracts. In other embodiments, more or less data can be used to organize the catalog. In yet other embodiments, the catalog can be organized by order of appearance of the products or services within the artistic work. In other embodiments, the catalog can be ordered by cost, or popularity of the products and services. When the catalog is organized, method 100 can proceed to block 114.

At block 114, the catalog is transmitted from the application server 410 to the front-end electronic device 501. In some embodiments, the catalog can be displayed to the user, on the front-end electronic device 501, during the playback of an artistic work. For example, the user can be watching a music video. During playback of the music video, a catalog of products associated with the music video (e.g., provided by merchant, artist, etc.) can be displayed to the user during playback of the music video. The user can then select items from the catalog. The user can purchase the items displays from the catalog. The user can share the items by message or social media. In at least one embodiment, the catalog is displayed on the front-end electronic device and the artistic work is displayed on a second front-end electronic device. When the catalog has been display method 100 can end.

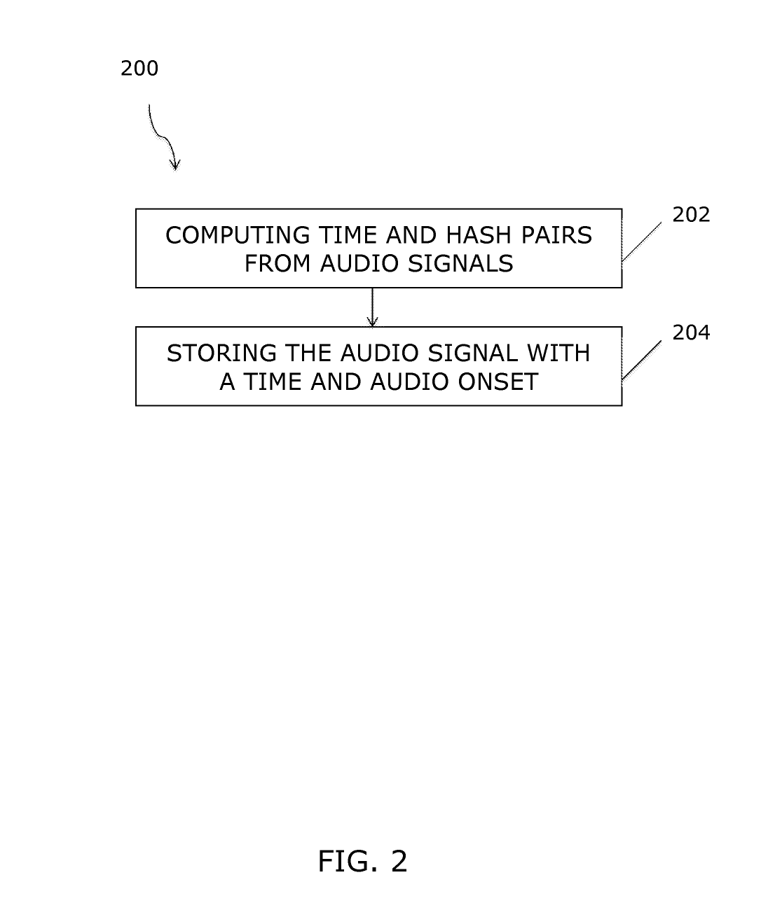

Referring to FIG. 2, a flowchart for search and audio recognition is presented in accordance with an example embodiment. In some embodiments, visual recognition can be performed. The example method 200 is provided by way of example, as there are a variety of ways to carry out the method. Each block shown in FIG. 2 represents one or more processes, methods or subroutines, carried out in the example method 200. Furthermore, the illustrated order of blocks is illustrative only and the order of the blocks can change according to the present disclosure. Additional blocks may be added or fewer blocks may be utilized, without departing from this disclosure. The blocks illustrated in FIG. 1 can be implemented in a system illustrated in FIGS. 4-5. The flow charts illustrated in FIG. 1, will be described in relation to and make reference to at least application server 401, back-end 507, front-end 501, and search platform 508 as illustrated in FIGS. 4-5. The example method 200 can begin at block 202.

At block 202, an application server 401 can compute a time and hash pairs from an audio signal. For example, the application server 401 can compute the time and hash pairs by using a code generator to process digital audio data and combine amplitude peak frequencies with the time difference between peaks to generate a unique audio print. Each audio print can be associated with a unique index for audio track identification and a time offset from start of audio sample (time, hash pair). The audio signal can be processed through a whitening filter. For example, the whitening filter can enhance low-level spectral components of the audio signal and attenuates high level spectral components of the audio signal. In some embodiments, the whitening filter can be used to filter out background noise of the audio signal. In some embodiments, the time and hash pairs can be used as markers indicating the specific location of a product or serviced within an artistic work. In other embodiments, a time and hash pair can be computed from a video signal. The audio signal can also be hashed by sub-band decomposition. In at least one embodiment, the audio signal can be hashed by 8-band sub-band decomposition. In some embodiments, a specific product or service can be associated with a specific time and hash pair, thereby identifying within the artistic work the location of the specific product or service. When the time and hash pairs have been computed, method 200 can proceed to block 204.

At block 204, the audio signal can be stored at the application server 401 with the time of the audio onset. For example, an audio print storage 408 communicatively coupled to the application server 401 can store a plurality of audio signals and the associated audio onset (i.e., the time after the audio silence). When the audio signal is stored at the application server 401 method 200 can end.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

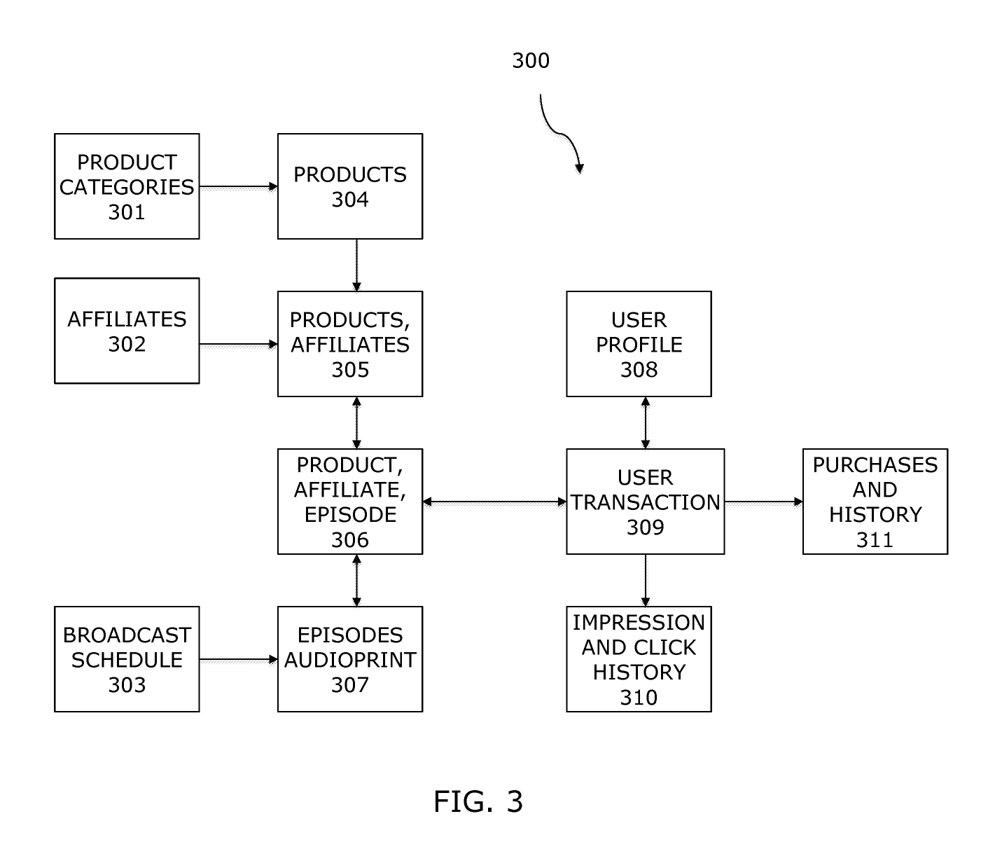

Referring to FIG. 3, a block diagram of an example data architecture 300 according to an embodiment of the present disclosure. Data architecture 300 can include product categories 301. For example, product categories can include electronics, home, garden, tools, automotive, books, sports, outdoors, clothing, jewelry, or any other category that can be used to define products and services. Product categories 301 can include a plurality of products 304. In other embodies, products 304 can include services. For example, products and services 304 can include, televisions, radios, audio players, stereos, couches, chairs, dining tables, lamps, vases, plants, flowers, shovels, drills, hammers, cars, trucks, motorcycles, baseball gloves, soccer balls, hunting rifles, t-shirts, jeans, slacks, travel, airplane travel, hotel accommodations, tours, or any other consumer product or service.

Data architecture 300 can also include affiliates 302. In some embodiments, affiliates 302 can be retailers. In some embodiments, affiliates can provide users options to purchase the products 304. Data architecture can further comprise a correlation 305 between products 304 and affiliates 302. In some embodiments, the correlation 305 can enable a user to view a product or service and also an affiliate where the product or service can be purchased. In some embodiments, the correlation 305 can enable the products 304 and affiliates 302 to be associated with an episode audio print 307 (e.g., an audio print of a television episode).

The data architecture 300 can further comprise broadcast schedules 303. In some embodiments, broadcast schedules 303 can be divided into a plurality of time slots. For example, broadcast schedules 303 can include a television programming schedules, radio schedules, episode schedules, episode playlists music playlist, network programming schedules, movie programming schedules or any other type of schedule for the production of producing audio or visual programming. The data architecture 300 can also include episode audio print 307. In some embodiments, an episode audio print 307 can be a time coded artistic work where product 304 can be associated. In some embodiments, episode audio print 307 can be included in the broadcast scheduled 303. For example, broadcast schedule 303 can contain one or more episode audio prints 307 which correspond to one or more time slots of the broadcast schedule 307.

The data architecture 300 can further comprise a correlation 306. In some embodiments, correlation 306 can comprise audio prints 307, products 304 and affiliates 302. In some embodiments, correlation 306 can be a combination of one or more episode audio print 307, and the one or more correlation 305 between products 304 contained within the one or more episode audio prints 307 and the affiliates 302 where the products 304 can be purchased. For example, the one or more products 304 can be associated with one or more onsets of episode audio print 307. The products 304 can be presented to a user viewing the episode audio print 307. The user can purchase the product 304 through the associated affiliate 302.

Still referring to FIG. 3, a user transaction 309 can request from the correlation 306, details of products 304 viewed during the broadcast schedule 309. The user transaction request 309 can be an episode audio print, text search, voice search, geo-tag or customer preferences. In some embodiments, the user transaction request 309 can also be performed automatically by a user profile 308, purchase and history 311 or impression and click history 310. The impression or click history 410 can include user-voting counts for artistic works and items to be created. This data can be used to predict demands (i.e., of a user) for artistic works views, item purchases, and product purchases. The user profile 308 can include name, address, e-mail address, payment information, product preferences, service preferences, audio and video preferences, and demographic information (e.g., age, gender, etc). The purchases and history 311 can include purchases made by a user (e.g., of products or service 304 from affiliates 302). The purchases and history 311 can also include a history of episode audio prints 307 (e.g., artistic works, videos, audio, etc.) watched or request. The impressions and click history 310 can include products viewed or clicked through during the playback of an episode audio print 307. In some embodiments, the user transaction request 309 can be performed in the background and the user can be notified of potential interested matches based on their profile 308, purchase and history 311 or impression and click history 310. In response to a user transaction 309, the user can receive the products 304 and affiliates 302 associated with the episode audio print 306.

FIG. 4 illustrates a block diagram of an example back-end system architecture 400. Back-end system architecture 400 can include one or more application servers 401. In some embodiments, the application server 401 can include a software framework to handle all application operations and interactions with the users. Application server 401 can include one or more processors 402 for carrying out the instructions of the application server 401. Application server 401 can include a network interface 403 for transmitting and receiving data (e.g., over the Internet, etc.). Application server 401 can include an I/O management 404 can be configured to monitor all input and output to and from the application server 401. Application server 401 can include a data store 405. Data store 405 can include a cache memory 406, database 407, audio print storage 408, and a cache diagnostics 409. The cache memory 406 and cache diagnostics 409 are utilized to manage system performance and enhance the user experience through delivering a highly responsive system.

FIG. 5 is a block diagram illustrating an example front-end and back-end system architecture. System architecture 500 can include a front-end 501 and a back-end 507. Front-end 501 can be an electronic device. For example, a smartphone, tablet, personal digital assistant, desktop computer, laptop, etc. The front-end 501 can run a variety of operating systems. For example, WebOS 502, iOS 503, Android 504, Windows 505, Fire 506, etc. The operating system can be run on front-end 501 by at least a processor and memory (not shown). Front-end 501 can be communicatively coupled to back-end 507 through a communication network (e.g., the Internet).

In some embodiments, back-end 507 can be a cloud-computing environment. In other embodiments, back-end 507 can be one or more servers. Back-end 507 can include a search platform 508. In some embodiments, the search platform 508 can receive search requests from users. For example, a search platform 508 can receive a search request for an artistic work from a user of a front-end device. The search platform can be communicatively coupled to application server 514. In some embodiments application server 514 can be substantially similar to application server 401 (as illustrated in FIG. 4). In some embodiments, application server 514 can include an application framework 509. Application framework 509 can be configured to handle all application operations and interactions with the users. Application server 514 can also include a load balance 510, HTTP performance 511, push 512 and wsgi server 513. The load balance 510 balances and distributes system workload across multiple computing resources, and the HTTP performance 511, push 512 and WSGI servers 513 can serve as a universal interface between web servers and web applications.

In at least one embodiment, the present technology can be implemented as a software or a hardware module. In at least one embodiment, the present technology causes a processor to execute instructions. The software module can be stored within a memory device or a drive. The present technology can be implemented with a variety of different drive configurations including Network File System (NFS), Internet Small Computer System Interface (iSCSi), and Common Internet File System (CIFS). Additionally, the present technology can be configured to run on VMware ESXi (which is an operating system-independent hypervisor based on the VMkernel operating system interfacing with agents that run on top of it. Additionally, the present technology can be configured to run on Amazon® Web Service in VPC.

Examples within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the scope of the disclosure.

What is claimed is:

1. A computer-implemented method comprising:
receiving, at a server, an audio signal;
receiving, at the server, identifying information;
calculating, at the server, an audio print of the audio signal;
retrieving, from a database, a catalog based on a match of the audio print;
organizing, at the server, the catalog based on the identifying information;
transmitting, from the server, the catalog.

2. The computer-implemented method of claim 1, wherein the audio signal is portion of a larger audio signal.

3. The computer-implemented method of claim 1, wherein the audio signal is associated with a video signal.

4. The computer-implemented method of claim 1, wherein the identifying information is a current location

5. The computer-implemented method of claim 1, wherein the identifying information is a preference.

6. The computer-implemented method of claim 1, wherein the catalog includes one or more products or services.

7. The computer-implemented method of claim 1, wherein the catalog is organized based on a current playback time of the audio signal.

8. A non-transitory computer-readable medium containing instructions that, when executed by a processor, cause the processor device to perform operations of:
receive an audio signal;
receive identifying information;
calculate an audio print of the audio signal;
retrieve a catalog based on a match of the audio print;
organize the catalog based on the identifying information;
transmit the catalog.

9. The non-transitory computer-readable medium of claim 8, wherein the audio signal is portion of a larger audio signal.

10. The non-transitory computer-readable medium of claim 8, wherein the audio signal is associated with a video signal.

11. The non-transitory computer-readable medium of claim 8, wherein the identifying information is a current location

12. The non-transitory computer-readable medium of claim 8, wherein the identifying information is a preference.

13. The non-transitory computer-readable medium of claim 8, wherein the catalog includes one or more products or services.

14. The non-transitory computer-readable medium of claim 8, wherein the catalog is organized based on a current playback time of the audio signal.

15. A system comprising:
a processor; and
a memory coupled to the processor to store instructions, which when executed by the processor, cause the processor to perform operations of:
receive an audio signal;
receive identifying information;
calculate an audio print of the audio signal;
retrieve a catalog based on a match of the audio print;
organize the catalog based on the identifying information;
transmit the catalog.

16. The system of claim 15, wherein the audio signal is portion of a larger audio signal.

17. The system of claim 15, wherein the audio signal is associated with a video signal.

18. The system of claim 15, wherein the identifying information is a current location

19. The system of claim 15, wherein the identifying information is a preference.

20. The system of claim 15, wherein the catalog is organized based on a current playback time of the audio signal.
